(19) United States
(12) Patent Application Publication
(10) Pub. No.: US 2018/0275714 A1
(43) Pub. Date: Sep. 27, 2018

(54) INDUCTIVE COUPLING FOR DATA COMMUNICATION IN A DOUBLE DATA RATE MEMORY SYSTEM

(71) Applicant: Integrated Device Technology, Inc., San Jose, CA (US)

(72) Inventors: David Chang, Santa Clara, CA (US); Xudong Shi, San Jose, CA (US); Shubing Zhai, San Jose, CA (US); Chenxiao Ren, Fremont, CA (US)

(21) Appl. No.: 15/468,310

(22) Filed: Mar. 24, 2017

(51) Int. Cl. G06F 1/12; G06F 13/42; G06F 1/10; G06F 13/40

(52) U.S. Cl. CPC G06F 1/12; G06F 13/4072; G06F 1/10; G06F 13/4291

(57) ABSTRACT

An apparatus comprising an input interface an output interface and a coupling interface. The input interface may comprise a plurality of input stages each configured to (i) receive a data signal and a coupled clock signal and (ii) present an intermediate signal. The output interface may comprise a plurality of output stages each configured to (i) receive the intermediate signal from one of the input stages, (ii) receive the coupled clock signal and (iii) present an output signal. The coupling interface may be configured to (i) receive the clock signal and (ii) present the coupled clock signal to each of (a) the input stages and (b) the output stages. The coupling interface may generate a plurality of inductive couples and (b) the inductive couples may enable a synchronization of the coupled clock signal with the clock signal for each of the input stages and the output stages.

### FIELD OF THE INVENTION

The invention relates to synchronous serial communication generally and, more particularly, to a method and/or apparatus for implementing inductive coupling for data communication in a double data rate (DDR) memory system.

### BACKGROUND

In serializer/deserializer (serdes) data communication, such as double data rate fourth generation (DDR4) and fifth generation (DDR5), a source synchronization input clock and data are received and transmitted through an input/output (I/O) pad. Within a multiple data bit/single clock path, the circuit design needs to balance clock and data skew to meet a skew specification. Skew balance becomes a very challenging and difficult specification to satisfy at a high data rate due to data bit and clock mismatch. Device process variation results in a delay mismatch between the data bits. Layout, IR drop, clock tree and driver mismatch each contribute to the mismatch of all the data bits and the clock path. A clock tree delay (i.e., a mclk signal) contributes to the total delay for the setup time.

It would be desirable to implement inductive coupling for data communication in a double data rate (DDR) memory system.

### SUMMARY

The invention concerns an apparatus comprising an input interface an output interface and a coupling interface. The input interface may comprise a plurality of input stages each configured to (i) receive a data signal and a coupled clock signal and (ii) present an intermediate signal. The output interface may comprise a plurality of output stages each configured to (i) receive the intermediate signal from one of the input stages, (ii) receive the coupled clock signal and (iii) present an output signal. The coupling interface may be configured to (i) receive the clock signal and (ii) present the coupled clock signal to each of (a) the input stages and (b) the output stages. The coupling interface may generate a plurality of inductive couples and (b) the inductive couples may enable a synchronization of the coupled clock signal with the clock signal for each of the input stages and the output stages.

### BRIEF DESCRIPTION OF THE FIGURES

Embodiments of the invention will be apparent from the following detailed description and the appended claims and drawings in which:

FIG. 1 is a diagram illustrating an example embodiment of a memory system;

FIG. 2 is a block diagram illustrating a memory module of FIG. 1;

FIG. 3 is a block diagram illustrating an example data buffer of FIG. 1;

FIG. 4 is a diagram illustrating a registered clock driver (RCD) in accordance with an embodiment of the invention;

FIG. 5 is a block diagram illustrating an example embodiment of the present invention;

FIG. 6 is a diagram illustrating an example embodiment of the apparatus comprising a coupling interface implementing inductor-to-inductor coupling with similar sizes;

FIG. 7 is a diagram illustrating an example embodiment of the apparatus comprising a coupling interface implementing a large transmitter inductor;

FIG. 8 is a diagram illustrating a coupling interface implementing an array of inductor-to-inductor couples;

FIG. 9 is a diagram illustrating a coupling interface implementing a large transmitting inductor and an array of receiving inductors;

FIG. 10 is a diagram illustrating an alternate example embodiment of the present invention;

FIG. 11 is a diagram illustrating an example embodiment of the apparatus configured to implement inductor coupling for data and clock signals; and

FIG. 12 is a diagram illustrating a coupling interface implementing a clock inductor couple and an array of data inductor couples.

### DETAILED DESCRIPTION OF THE EMBODIMENTS

Embodiments of the present invention include providing inductive coupling for data communication in a double data rate (DDR) memory system that may (i) be implemented in a registered clock driver (RCD), (ii) be implemented in a data buffer (DB), (iii) replace a clock tree, (iv) reduce a mismatch between bit to bit and clock tree delay, (v) deliver a signal globally through a magnetic field, (vi) meet and/or exceed a skew specification for double data rate memory and/or (vii) be implemented as one or more integrated circuits.

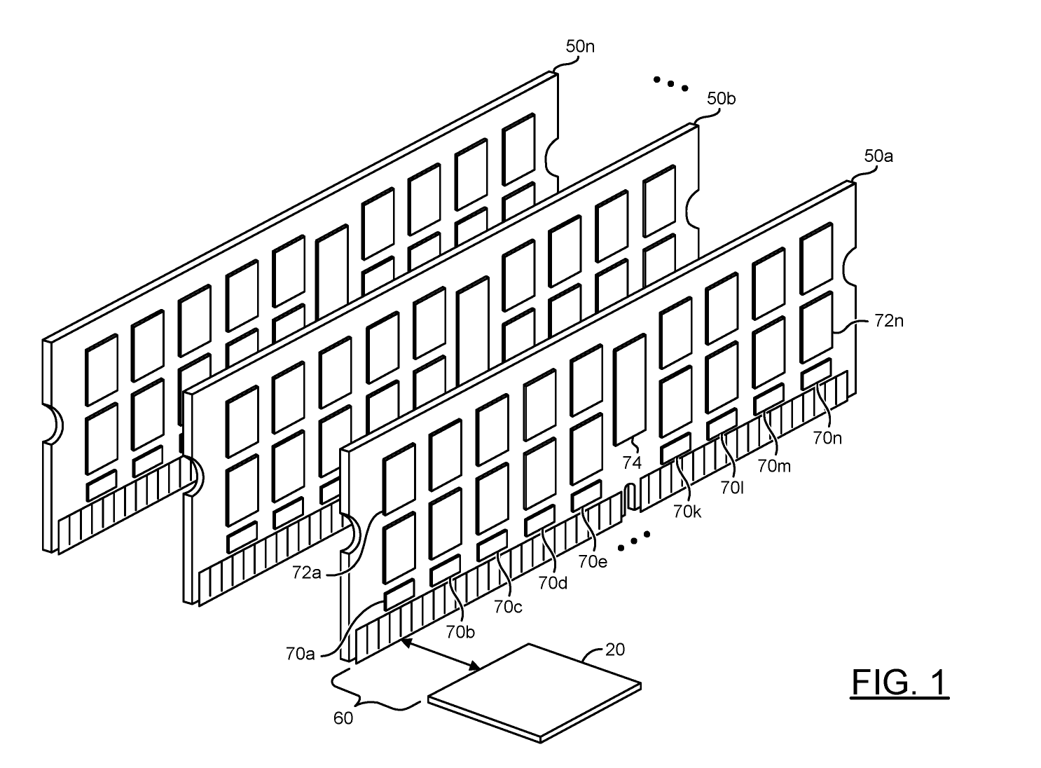

Referring to FIG. 1, a diagram of a memory system is shown in accordance with an example embodiment of the invention. In various embodiments, the memory system includes a number of circuits 50a-50n. The circuits 50a-50n may be implemented as memory modules (or boards). In an example, the circuits 50a-50n may be implemented as dual in-line memory modules (DIMMs). In some embodiments, the circuits 50a-50n may be implemented as double data rate fourth generation (DDR4) synchronous dynamic random-access memory (SDRAM) modules. In some embodiments, the circuits 50a-50n may be implemented as double data rate fifth generation (DDR5) SDRAM modules.

In various embodiments, the circuits 50a-50n may comprise a number of blocks (or circuits) 70a-70n, a number of blocks (or circuits) 72a-72n, a block (or circuit) 74 and/or various other blocks, circuits, pins, connectors and/or traces. The circuits 70a-70n may be configured as data buffers. The circuits 72a-72n may implement memory devices. In an example, the circuits 72a-72n may be implemented as synchronous dynamic random-access memory (SDRAM) devices (or chips, or modules). The circuit 74 may be implemented as a registered clock driver (RCD). In an example, the RCD circuit 74 may be implemented as a DDR4 RCD circuit. In another example, the RCD circuit 74 may be implemented as a DDR5 RCD circuit. The type, arrangement and/or number of components of the memory modules 50a-50n may be varied to meet the design criteria of a particular implementation.

The memory modules 50a-50n are shown connected to a block (or circuit) 20. The circuit 20 may implement a memory controller. The circuit 20 may be located in another device, such as a computing engine. Various connectors/pins/traces 60 may be implemented to connect the memory modules 50a-50n to the memory controller 20. In some embodiments, the connectors/pins/traces 60 may be a 288-pin configuration. In an example, the memory controller 20 may be a component of a computer motherboard (or main board). In another example, the memory controller 20 may be a component of a microprocessor. In yet another example, the memory controller 20 may be a component of a central processing unit (CPU).

In an example, some of the connectors/pins/traces 60 may be part of the memory modules 50a-50n and some of the connectors/pins/traces 60 may be part of the motherboard and/or memory controller 20. The memory modules 50a-50n may be connected to the computer motherboard (e.g., by pins, traces and/or connectors 60) to transfer data between components of a computing device and the memory modules 50a-50n. In an example, the memory controller 20 may be implemented on a northbridge of the motherboard and/or as a component of a microprocessor (e.g., an Intel CPU, an AMD CPU, an ARM CPU, etc.). The implementation of the memory controller 20 may be varied according to the design criteria of a particular implementation.

In various embodiments, the circuits 50a-50n may be implemented as DDR4 (or DDR5) SDRAM memory modules. In an example, the circuits 50a-50n may have a memory module density of 512 gigabyte (GB), one terabyte (TB), or higher per module (e.g., compared to 128 GB per dual in-line memory module (DIMM) in DDR3). In embodiments implementing DDR4 SDRAM memory modules, the circuits 50a-50n may operate at voltages of 1.2-1.4 volts (V) with a frequency between 800-4266 megahertz (MHZ) (e.g., compared to 1.5-1.65V at frequencies between 400-1067 MHZ in DDR3). In some embodiments, the circuits 50a-50n may be implemented as low voltage DDR4 memory modules and operate at 1.05V. For example, in embodiments implementing low voltage DDR4 SDRAM memory modules, the circuits 50a-50n may implement 35% power savings compared to DDR3 memory. In embodiments implementing DDR4 SDRAM memory modules, the circuits 50a-50n may transfer data at speeds of 2.13-4.26 giga-transfers per second (GT/s) and higher (e.g., compared to 0.8-2.13 GT/s in DDR3). The operating parameters of the memory modules 50a-50n may be varied according to the design criteria of a particular implementation.

In an example, the memory modules 50a-50n may be compliant with the DDR4 specification entitled “DDR4 SDRAM”, specification JESD79-4A, November 2013, published by the Joint Electron Device Engineering Council (JEDEC) Solid State Technology Association, Arlington, Va. Appropriate sections of the DDR4 specification are hereby incorporated by reference in their entirety.

The memory modules 50a-50n may be implemented as DDR4 load reduced DIMM (LRDIMM). The data buffers 70a-70n may allow the memory modules 50a-50n to operate at higher bandwidth and/or at higher capacities compared to DDR4 RDIMM (e.g., 2400 or 2666 MT/s for DDR4 LRDIMM compared to 2133 or 2400 MT/s for DDR4 RDIMM at 384 GB capacity). For example, compared to DDR4 RDIMM configurations, the DDR4 LRDIMM configuration of the memory modules 50a-50n may allow improved signal integrity on data signals and/or better intelligence and/or post-buffer awareness by the memory controller 20.

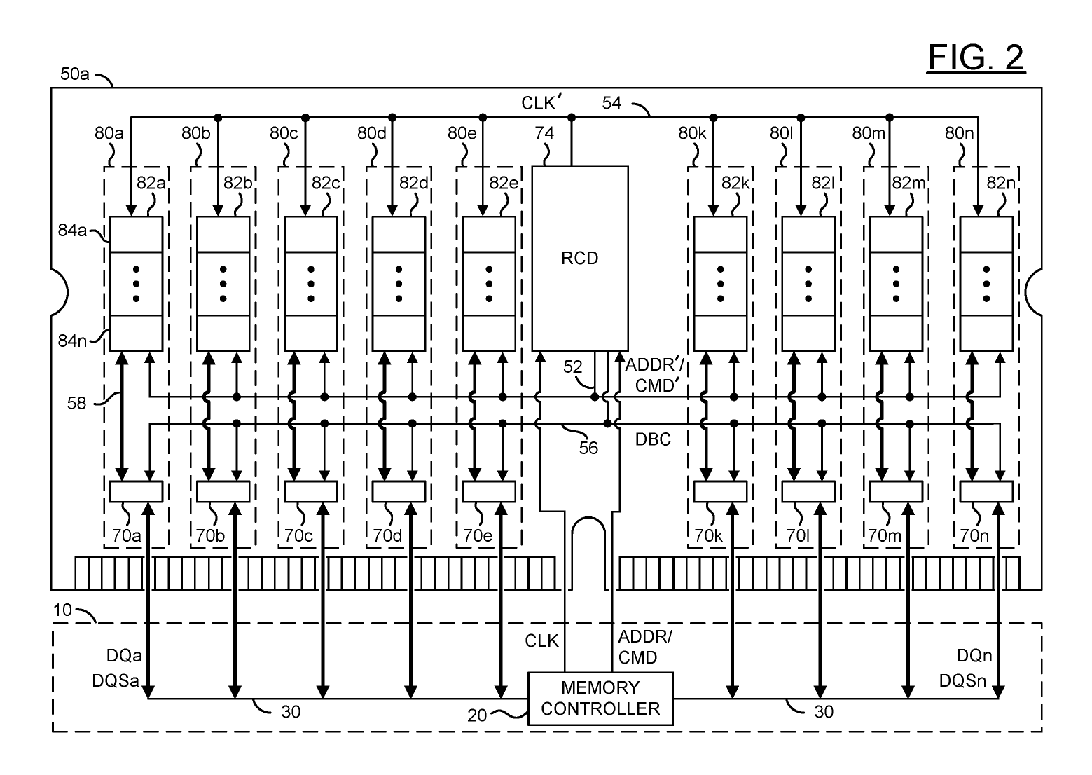

Referring to FIG. 2, a block diagram is shown illustrating a memory module 50a of FIG. 1. The memory module 50a may be representative of the memory modules 50b-50n. The memory module 50a is shown communicating with the memory controller 20. The memory controller 20 is shown as part of a block (or circuit) 10. The circuit 10 may be a motherboard (or main board), or other electronic component or computing engine that communicates with the memory module 50a.

The memory module 50a may comprise one or more blocks (or circuits) 80a-80n and/or the RCD circuit 74. The circuits 80a-80n may implement data paths of the memory module 50a. For example, the data path 80a may include a block 82a and/or the data buffer 70a. The data paths 80b-80n may have similar implementations. The circuits 82a-82n may each be implemented as a memory channel. Each of the memory channels 82a-82n may comprise a number of blocks (or circuits) 84a-84n. The circuits 84a-84n may be implemented as random access memory (RAM) chips. For example, the RAM chips 84a-84n may implement a volatile memory such as dynamic RAM (DRAM). The RAM chips 84a-84n may be the SDRAM devices 72a-72n (e.g., the chips 84a-84n may comprise one or more of the circuits 72a-72n located within one of the memory channels 82a-82n). In some embodiments, the RAM chips 84a-84n may be physically located on both sides (e.g., the front and back) of the circuit board of the memory modules 50a-50n. A capacity of memory on the memory module 50a may be varied according to the design criteria of a particular implementation.

The memory controller 20 may generate a signal (e.g., CLK) and a number of control signals (e.g., ADDR/CMD). The signal CLK and/or the signals ADDR/CMD may be presented to the RCD circuit 74. A data bus 30 may be connected between the memory controller and the data paths 80a-80n. The memory controller 20 may generate and/or receive data signals (e.g., DQa-DQn) and data strobe signals (e.g. DQSa-DQSn) that may be presented/received from the data bus 30. Portions of the signals DQa-DQn and DQSa-DQSn may be presented to respective data paths 80a-80n.

The RCD circuit 74 may be configured to communicate with the memory controller 20, the memory channels 82a-82n and/or the data buffers 70a-70n. The RCD circuit 74 may decode instructions received from the memory controller 20. For example, the RCD circuit 74 may receive register command words (RCWs). In another example, the RCD circuit 74 may receive buffer control words (BCWs). The RCD circuit 74 may be configured to train the DRAM chips 84a-84n, the data buffers 70a-70n and/or command and address lines between the RCD circuit 74 and the memory controller 20. For example, the RCWs may flow from the memory controller 20 to the RCD circuit 74. The RCWs may be used to configure the RCD circuit 74. The RCD circuit 74 may be used in both LRDIMM and RDIMM configurations. The RCD circuit 74 may implement a 32-bit 1:2 command/address register. The RCD circuit 74 may support an at-speed bus (e.g., a BOOM bus between the RCD circuit 74 and the data buffers 70a-70n). The RCD circuit 74 may implement automatic impedance calibration. The RCD circuit 74 may implement command/address parity checking. The RCD circuit 74 may control register RCW readback. The RCD circuit 74 may implement a 1 MHz inter-integrated circuit (I²C) bus (e.g., a serial bus). Inputs to the RCD circuit 74 may be pseudo-differential using external and/or internal voltages. The clock outputs, command/address outputs, control outputs and/or data buffer control outputs of the RCD circuit 74 may be enabled in groups and independently driven with different strengths.

The RCD circuit 74 may receive the signal CLK and/or the signals ADDR/CMD from the memory controller 20. Various digital logic components of the RCD circuit 74 may be used to generate signals based on the signal CLK and/or the signals ADDR/CMD and/or other signals (e.g., RCWs). The RCD circuit 74 may also be configured to generate a signal (e.g., CLK′) and signals (e.g., ADDR′/CMD′). For example, the signal CLK′ may be a signal Y_CLK in the DDR4 specification. The signal CLK′ and/or the signals ADDR′/CMD′ may be presented to each of the memory channels 82a-82n. For example, the signals ADDR′/CMD′ and CLK′ may be transmitted on a common bus 52 and a common bus 54, respectively. The RCD circuit 74 may generate one or more signals (e.g., DBC). The signals DBC may be presented to the data buffers 70a-70n. The signals DBC may implement data buffer control signals. The signals DBC may be transmitted on a common bus 56 (e.g., a data buffer control bus). The data buffers 70a-70n may be configured to receive commands and data from the bus 56. The data buffers 70a-70n may be configured to generate/receive data to/from the bus 30. The bus 30 may comprise traces, pins and/or connections between the memory controller 20 and the data buffers 70a-70n. A bus 58 may carry the data between each of the data buffers 70a-70n and respective memory channels 82a-82n. The data buffers 70a-70n may be configured to buffer data on the buses 30 and 58 for write operations (e.g., data transfers from the memory controller 20 to the corresponding memory channels 82a-82n). The data buffers 70a-70n may be configured to buffer data on the buses 30 and 58 for read operations (e.g., data transfers from the corresponding memory channels 82a-82n to the memory controller 20).

The data buffers 70a-70n may exchange data with the DRAM chips 84a-84n in small units (e.g., 4-bit nibbles). In various embodiments, the DRAM chips 84a-84n may be arranged in multiple (e.g., two) sets. For two set/two DRAM chip (e.g., 84a-84b) implementations, each set may contain a single DRAM chip (e.g., 84a or 84b). Each DRAM chip 84a-84b may be connected to the respective data buffers 70a-70n through an upper nibble and a lower nibble. For two set/four DRAM chip (e.g., 84a-84d) implementations, each set may contain two DRAM chips (e.g., 84a-84b or 84c-84d). A first set may be connected to the respective data buffers 70a-70n through the upper nibble. The other set may be connected to the respective data buffers 70a-70n through the lower nibble. For two set/eight DRAM chip (e.g., 84a-84h) implementations, each set may contain four of the DRAM chips 84a-84h. A set of four DRAM chips (e.g., 84a-84d) may connect to the respective data buffers 70a-70n through the upper nibble. The other set of four DRAM chips (e.g., 84e-84h) may connect to the respective data buffers 70a-70n through the lower nibble. Other numbers of sets, other numbers of DRAM chips, and other data unit sizes may be implemented to meet the design criteria of a particular implementation.

The DDR4 LRDIMM configuration may reduce a number of data loads to improve signal integrity on a data bus (e.g., the bus 30) of the memory module from a maximum of several (e.g., four) data loads down to a single data load. The distributed data buffers 70a-70n may allow DDR4 LRDIMM designs to implement shorter I/O trace lengths compared to DDR3 LRDIMM designs, which use a centralized memory buffer. For example, shorter stubs connected to the memory channels 82a-82n may result in less pronounced signal reflections (e.g., improved signal integrity). In another example, the shorter traces may result in a reduction in latency (e.g., approximately 1.2 nanoseconds (ns), which is 50% less latency than DDR3 buffer memory). In yet another example, the shorter traces may reduce I/O bus turnaround time. For example, without the distributed data buffers 70a-70n (e.g., in DDR3 memory applications) traces would be routed to a centrally located memory buffer, increasing trace lengths up to six inches compared to the DDR4 LRDIMM implementation shown in FIG. 2.

In some embodiments, the DDR4 LRDIMM configuration may implement nine of the data buffers 70a-70n. The memory modules 50a-50n may implement 2 millimeter (mm) frontside bus traces and backside traces (e.g., the connectors/pins/traces 60). A propagation delay through the data buffers 70a-70n may be 33% faster than through a DDR3 memory buffer (e.g., resulting in reduced latency). In some embodiments, the data buffers 70a-70n may be smaller (e.g., a reduced area parameter) than a data buffer used for DDR3 applications.

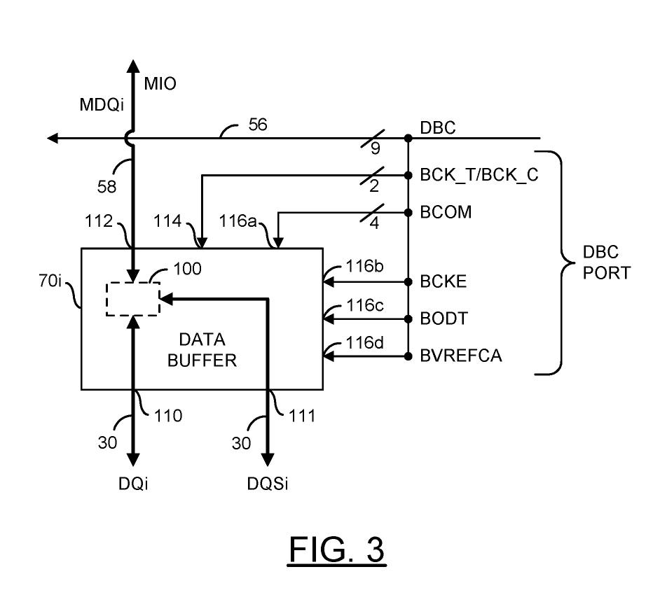

Referring to FIG. 3, a diagram is shown illustrating a data buffer 70i in accordance with an example embodiment of the invention. The data buffer 70i may be representative of an example embodiment of the data buffers 70a-70n. The data buffer 70i is shown having a first input/output 110, a second input/output 111, and a third input/output 112.

The first input/output 110 is configured for presenting/receiving the signals DQi (e.g., the data signals DQ corresponding to a memory channel) between the data buffer 70i and the controller 20. The second input/output 111 is configured for presenting/receiving the signals DQSi (e.g., the data strobe signals DQS corresponding to the memory channel) between the data buffer 70i and the controller 20. The third input/output 112 is configured for presenting/receiving the signals DQi as memory input/output (MIO) signals (e.g., MDQi) corresponding to a memory channel between the data buffer 70i and the respective memory devices (e.g., DRAM chips) 72a-72n.

The signals MDQi are generally transmitted between the memory modules 72a-72n and the respective data buffer 70a-70n. In an example, data (e.g., the signals DQi) from the memory controller 20 may be presented to the data buffer 70i, buffered in the data buffer 70i, then transmitted to the respective memory device(s) 72a-72n. In another example, data from the respective memory device(s) 72a-72n may be presented to the data buffer 70i, buffered in the data buffer 70i, and then transmitted on an appropriate memory channel to the memory controller 20.

The data buffer 70i is shown also receiving signals (e.g., DBC) from the bus 56 at a control port (e.g., DBC PORT). The signals DBC may be presented to the data buffers 70a-70n (e.g., using the data buffer control bus 56). In an example, the signals DBC are illustrated comprising five signals transmitted over 9 pins/bits (e.g., a pair of signals BCK_T/BCK_C, a signal BCOM, a signal BCKE, a signal BODT and/or a signal BVREFCA). However, other numbers of pins/bits may be implemented accordingly to meet the design criteria of a particular application. The control port of the data buffer 70i is shown having an input 114 receiving the signals BCK_T/BCK_C, an input 116a receiving the signal BCOM, an input 116b receiving the signal BCKE, an input 116c receiving the signal BODT, and an input 116d receiving the signal BVREFCA.

In various embodiments, the signals BCK_T/BCK_C may be implemented as a 2-bit signal representing a differential (e.g., true (T) and complementary (C) versions) clock signal for the duplex data buffers 70a-70n. In various embodiments, the signal BCOM may be implemented as a 4-bit signal representing data buffer commands. However, other numbers of bits may be implemented accordingly to meet the design criteria of a particular application. The signal BCOM may be implemented as a unidirectional signal from the RCD circuit 74 to the data buffers 70a-70n. In an example, the signal BCOM may be implemented at a single data rate (e.g., 1 bit per signal per clock cycle). However, a particular command may take a different number of clock cycles to transfer information. The signal BCKE may be a function registered dedicated non-encoded signal (e.g., DCKE). The signal BODT may be a function registered dedicated non-encoded signal (e.g., DODT). The signal BVREFCA may be a reference voltage for use with pseudo-differential command and control signals.

The data buffers 70a-70n may receive a set of data buffer commands (e.g., for writing buffer control words (BCWs)) from the signals DBC. The buffer control words may be used to customize operation of the data buffers 70a-70n. The buffer control words may flow from the memory controller 20, through the RCD circuit 74, to the data buffers 70a-70n. The buffer control words may be similar to register control words (RCWS) used for configuring the RCD circuit 74. Similar to commands for writing the register control words, the commands for writing the buffer control words may look like an MRS7 command, where the address lines are really the payload.

In embodiments where the bus 56 comprises nine pins, the RCD circuit 74 may do more than pass a buffer control word directly through to the data buffers 70a-70n. In one example, the RCD circuit 74 may convert (e.g., multiplex) an MRS7 command format into a buffer control word in a BCOM format. The RCD circuit 74 may map the 12 address bits of the MRS7 command into five separate data transfers, each 4 bits wide. The five data transfers may be set up back to back over the bus 56. For example, 5 clock cycles plus a parity cycle may be used to complete the buffer command in the buffer control word. Once the buffer control word reaches the data buffers 70a-70n, the data buffers 70a-70n may decode the buffer control word, write the buffer control word to a function space of the data buffer, and complete the buffer command in the buffer control word.

A function of the signal BCOM may be to transmit the buffer control words. However, compliant with the JEDEC specification for DDR4 SDRAM, the RCD circuit 74 may send all read/write commands and MRS information over the bus 56 (e.g., to allow the data buffers 70a-70n to keep track of what the memory devices 72 are doing). In some embodiments, different buffer commands may take a different number of cycles to transfer the information.

The RCD circuit 74 may receive an MRS7 command from the memory controller 20 (e.g., from a host). For example, a host may want to change a parameter (e.g., typically on initialization or boot up of a computing device). The RCD circuit 74 may check the MRS7 command to determine whether the address bit 12 is set to 1 (e.g., a logical one). In an example, when an address bit 12 of the MRS7 command is set to 1, the RCD circuit 74 may recognize the command as a buffer command (e.g., a command that is not meant for the RCD circuit 74). The RCD circuit 74 may convert the command from the memory controller 20 to a buffer control word and send the buffer control word to the data buffers 70a-70n via the bus 56. The data buffers 70a-70n may write the buffer control word to a function space to complete the command.

The data buffers 70a-70n may be configurable. The buffer commands may allow the memory controller 20 to customize aspects of termination (e.g., ODT), signal strength on the DQ lines, and/or events (e.g., receiver timing, driver timing, etc.) in both directions (e.g., for both read and write operations). In some embodiments, some of the configurations of the data buffers 70a-70n may be decided based on system level configurations. Generally, most of the configuration of the data buffers 70a-70n may be decided during training steps. During training steps, host controllers (e.g., the memory controller 20) may test and compare results of various training steps to determine an optimal configuration.

In various embodiments, the bus 56 may be used to send commands/data to program configuration registers of the data buffers 70a-70n. The bus 56 may also send commands (e.g., data reads and/or data writes) that control data traffic through the data buffers 70a-70n. For example, some commands may optimize power consumption and noise filtering (e.g. equalization) of the data buffers 70a-70n. In another example, read/write delays may be added per data line.

The data buffers 70a-70n may implement dual multi-bit (e.g., 4-bit) bidirectional data registers with differential data strobes (e.g., DQS_T/DQS_C). The data buffers 70a-70n may implement automatic impedance calibration. The data buffers 70a-70n may implement BCOM parity checking. The data buffers 70a-70n may implement control register (e.g., buffer control word) readback.

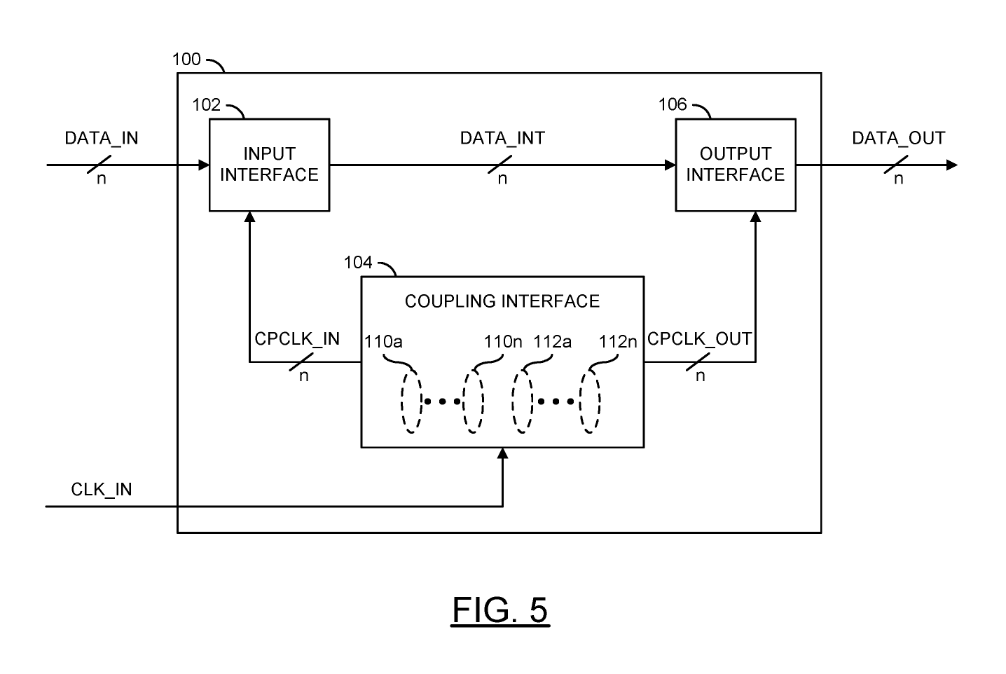

In some embodiments, the data buffers 70a-70n may comprise a block (or circuit) 100. The circuit 100 implemented in one or more of the data buffers 70a-70n may be configured to implement inductive coupling for data communication in a double data rate (DDR) memory system. In one example, the circuit 100 may be configured to implement inductive coupling for a clock signal and/or one or more data signals. In another example, the circuit 100 may implement a large transmitter inductor coupled with an array of receiver inductors. In yet another example, the circuit 100 may implement an array of inductor-to-inductor couples. Details of the circuit 100 may be described in association with FIGS. 5-12.

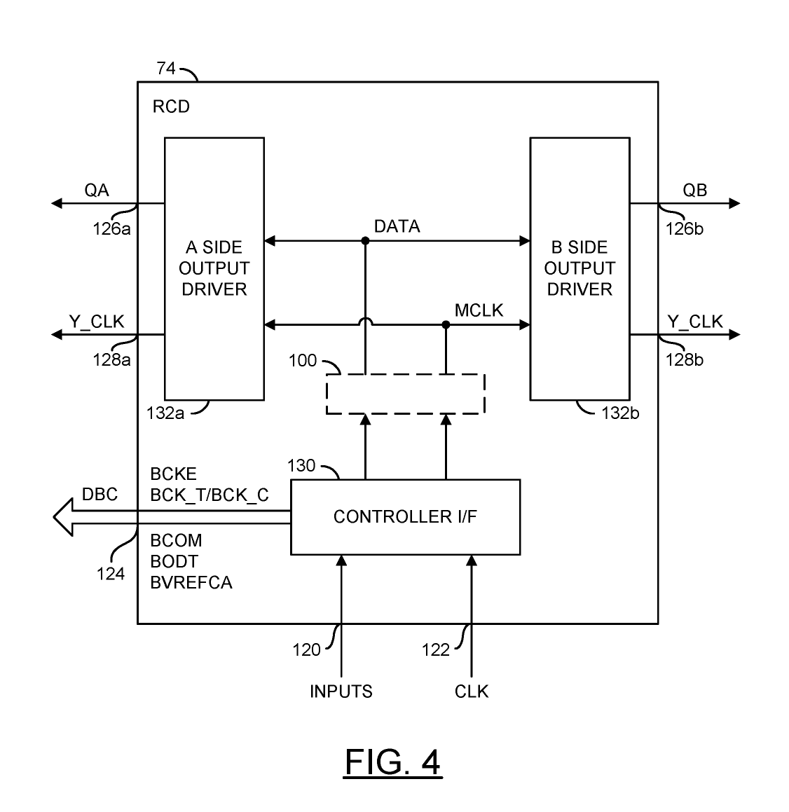

Referring to FIG. 4, a diagram is shown illustrating a registered clock driver in accordance with an embodiment of the invention. In various embodiments, a circuit 74 may implement a registered clock driver circuit (or chip). In various embodiments, the circuit 74 may be JEDEC compliant (e.g., compliant with the DDR4 specification entitled “DDR4 SDRAM”, specification JESD79-4A, November 2013, published by the Joint Electron Device Engineering Council (JEDEC) Solid State Technology Association, Arlington, Va.).

The circuit 74 may have an input 120 that receives input data (e.g., INPUTS), an input 122 that receives the clock signal CLK, an input/output 124 that may receive/transmit control information (e.g., DBC), outputs 126a and 126b that may provide data outputs (e.g., the Q outputs QA and QB, respectively) and outputs 128a and 128b that may provide output clock signals (e.g., Y_CLK). The signals INPUTS and CLK may be received from a memory controller (e.g., the memory controller 20 in FIG. 1) via a memory bus of a motherboard. In an example, the signals INPUTS may be pseudo-differential using an external or internal voltage reference. The signals INPUTS may comprise the ADDR/CMD signals of FIGS. 1 and 2. In an example, the signal CLK may be implemented as differential clock signals CLK_t (true) and CLK_c (complement). The signals QA, QB, and Y_CLK may be presented to a number of memory chips (e.g., 84a-84n in FIG. 2). For example, the signals QA, QB and Y_CLK may implement an output address and control bus for a DDR4 RDIMM, DDR4 LRDIMM, DDR4 UDIMM and/or DDR5 memory module. The signal DBC may be implemented as a data buffer control bus.

In various embodiments the circuit 74 may comprise a block 130, a block (or circuit) 132a and/or a block (or circuit) 132b. The block 130 may implement a controller interface. The blocks 132a and 132b may implement output driver circuits. In some embodiments, the blocks 132a and 132b may be combined as a single circuit 132. The block 130 may be configured to generate a data signal (e.g., DATA) and a clock signal (e.g., MCLK). The block 130 may be configured to generate the pair of signals BCK_T/BCK_C, the signal BCOM, the signal BCKE, the signal BODT and/or the signal BVREFCA. The signals DATA and MCLK may be presented to the blocks 132a and 132b. In various embodiments, the signal DATA may be coupled to the blocks 132a and 132b by combinatorial logic (not shown). The blocks 132a and 132b may be configured to generate the signals QA, QB and Y_CLK.

In various embodiments, the circuit 74 may be enabled to automatically adjust a skew time of a plurality of output pins during a manufacturing test operation. In various embodiments, the circuit 74 may be enabled to adjust the skew time (e.g., tSkew) to within a single gate delay of a reference output clock. As used herein, the term tSkew may be defined as the phase difference between an output data signal or pin (e.g., Q) and an output clock signal or pin (e.g., Y_CLK). In an example, a DDR4 registered clock driver (RCD) may have sixty-six output pins. However, other numbers of output pins may be implemented to meet the design criteria of a particular implementation (e.g., a DDR5 implementation).

The circuit 74 may be configured to adjust the phase of the output pins relative to the clock signal Y_CLK (or to respective copies of the clock signal Y_CLK) to meet manufacturer specifications (e.g., within +/−50 ps, etc.). The granularity of the phase adjustment is generally determined by delay elements within the circuit 74. During production testing, the circuit 74 may be configured to perform a trimming process in response to signals from automated test equipment and provide a pass/fail indication to the automated test equipment. In various embodiments, the circuit 74 may be utilized to implement the RCD in DDR4 RDIMM, DDR4 LRDIMM, DDR4 UDIMM and/or DDR5 memory modules.

In some embodiments, the RCD circuit 74 may comprise the circuit 100. In some embodiments, the circuit 100 may be implemented wholly or partially within the circuit 130, the circuit 132a and/or the circuit 132b. In some embodiments, the RCD circuit 74 may implement multiple instances of the circuit 100 (e.g., one implemented within the circuit 132a and another implemented within the circuit 132b). In some embodiments, the circuit 100 may be implemented as a component separate from the other components fo the RCD 74. The circuit 100 implemented within the RCD circuit 74 may be configured to implement inductive coupling for data communication in a double data rate (DDR) memory system. Details of the circuit 100 may be described in association with FIGS. 5-12.

Referring to FIG. 5, a block diagram illustrating the inductive coupling circuit 100 is shown. The inductive coupling circuit 100 may comprise a block (or circuit) 102, a block (or circuit) 104 and/or a block (or circuit) 106. The circuit 102 may implement an input interface. The circuit 104 may implement a coupling interface. The circuit 106 may implement an output interface. Each of the circuits 102-106 may comprise one or more blocks (or circuits). The number and/or types of components implemented by the circuit 100 may be varied according to the design criteria of a particular implementation.

The circuit 100 may implement a portion of the data path for the circuits 50a-50n. The inductive coupling circuit 100 may receive a signal (e.g., DATA_IN). The inductive coupling circuit 100 may receive a signal (e.g., CLK_IN). The signal CLK_IN may be an input clock signal. The signal DATA_IN may transmit input data. The signal DATA_IN may comprise n bits (e.g., signals DATA_IN1-DATA_INN). The inductive coupling circuit 100 may present a signal (e.g., DATA_OUT). The signal DATA_OUT may transmit output data. The signal DATA_OUT may comprise n bits (e.g., signals DATA_OUT1-DATA_OUTN). The number of bits transmitted by each signal may be varied according to the design criteria of a particular implementation.

In some embodiments (e.g., when the circuit 100 is implemented as part of one of the data buffers 70a-70n), the signal DATA_IN may be the signal DQ and/or DQi. In one example, (e.g., when the circuit 100 is implemented as part of the RCD circuit 74), the signal DATA_IN may be the signal INPUTS. In another example, (e.g., when the inductive coupling circuit 100 is implemented as part of the RCD circuit 74), the signal DATA_IN may be the signal DATA. In some embodiments, (e.g., when the inductive coupling circuit 100 is implemented as part of one of the data buffers 70a-70n), the signal DATA_OUT may be the signal MDQ. In one example, (e.g., when the inductive coupling circuit 100 is implemented as part of the RCD circuit 74), the signal DATA_OUT may be implemented as one or more of the Q outputs (e.g., QA and/or QB). In another example, (e.g., when the inductive coupling circuit 100 is implemented as part of the RCD circuit 74), the signal DATA_OUT may be implemented as the signal DATA. In some embodiments (e.g., when the inductive coupling circuit 100 is implemented as part of one of the data buffers 70a-70n), the signal CLK_IN may be one or more of the signals BCK_T and/or BCK_C. In one example, (e.g., when the inductive coupling circuit 100 is implemented as part of the RCD circuit 74), the signal CLK_IN may be the signal CLK. In another example, (e.g., when the inductive coupling circuit 100 is implemented as part of the RCD circuit 74), the signal CLK_IN may be the signal MCLK.

The input interface 102 may receive the signal DATA_IN and a signal (e.g., CPCLK_IN). The input interface 102 may present a signal (e.g., DATA_INT). The signal DATA_INT may be an intermediate data signal. The signal DATA_INT may comprise n bits (e.g., signals DATA_INTA-DATA_INTN). Generally, the number of bits of the signal DATA_IN, DATA_INT and/or DATA_OUT may be the same. The output interface 106 may receive the signal DATA_INT and a signal (e.g., CPCLK_OUT). The output interface 106 may present the signal DATA_OUT.

The coupling interface 104 may receive the signal CLK_IN. The coupling interface 104 may present the signal CPCLK_IN and the signal CPCLK_OUT. The signal CPCLK_IN may be a coupled version of the signal CLK_IN presented to the input interface 102. The signal CPCLK_IN may comprise n bits (e.g., signals CPCLK_INA-CPCLK_INN). Generally, the number of bits of the signal CPCLK_IN may correspond to a number of components of the input interface 102. The signal CPCLK_OUT may be a coupled version of the signal CLK_IN presented to the output interface 106. The signal CPCLK_OUT may comprise n bits (e.g., signals CPCLK_OUTA-CPCLK_OUTN). Generally, the number of bits of the signal CPCLK_OUT may correspond to a number of components of the output interface 106. Generally, the number of the components of the interface 102 and/or the interface 106 correspond of the data bits in the signal DATA_IN.

The inductive coupling circuit 100 may be configured to reduce and/or eliminate mismatch between bit to bit delay and clock tree delay. The inductive coupling circuit 100 may be implemented as a component of the data buffers 70a-70n and/or as a component in the RCD circuit 74. The coupling interface 104 may be implemented to synchronize the signal CLK_IN for each bit transmitted in the signal DATA_IN. Synchronizing the clock signal CLK_IN may clean up jitter and/or skew (e.g., adjust tSkew) through the clock line.

The coupling interface 104 may comprise a number of couples 110a-110n and a number of couples 112a-112n. The couples 110a-110n and the couples 112a-112n may have similar implementations. For example, couples 110a-110n may be implemented to couple the input clock signal CLK_IN with the coupled clock signal CPCLK_IN for the input interface 102 and the couples 112a-112n may be implemented to couple the input clock signal CLK_IN with the coupled clock signal CPCLK_OUT for the output interface 106.

The coupled clock signals CPCLK_IN and/or CPCLK_OUT may be signals that are induced in response to the couples 110a-110n and/or the couples 112a-112n. Inducing the coupled signals CPCLK_IN and/or CPCLK_OUT in response to the input clock signal CLK_IN may synchronize a timing of the coupled clock signals CPCLK_IN and/or CPCLK_OUT with the input clock signal CLK_IN. For example, as a result of the inductive couples 110a-110n, the timing of the coupled clock signal CPCLK_IN may match the timing of the input clock signal CLK_IN. Similarly, as a result of the inductive couples 112a-112n, the timing of the coupled clock signal CPCLK_OUT may match the timing of the input clock signal CLK_IN. The inductive couples 110a-110n and/or the inductive couples 112a-112n may synchronize the input clock signal CLK_IN, the coupled clock signal CPCLK_IN and the coupled clock signal CPCLK_OUT with each other. Synchronizing the clock signals CLK_IN, CPCLK_IN and/or CPCLK_OUT may implement timing for the components of the interface 102 and/or the interface 106 to reduce the bit-to-bit delay when transmitting the data signals (e.g., DATA_IN, DATA_INT and/or DATA_OUT).

The couples 110a-110n and/or the couples 112a-112n may comprise inductive (or magnetic) couples. The inductor couples 110a-110n and/or the couples 112a-112n may be configured to deliver the input clock CLK_IN from the source to the entire data path. The inductor couples 110a-110n and/or the couples 112a-112n may eliminate the delay and/or mismatch between bit to bit delay and the input clock since the inductor coupling signals (e.g., CPCLK_IN and/or CPCLK_OUT) may be delivered globally through the magnetic field in a near field. The magnetic energy of the inductive couples 110a-110n and/or the inductive couples 112a-112n may be received at the same time once the signal CPCLK_IN and/or the signal CPCLK_OUT are induced (e.g., transmitted). Implementing the inductive couples 110a-110n and/or the inductive couples 112a-112n may implement the data path without a clock tree.

In some embodiments, a fabrication process size for designing and/or manufacturing components of the memory circuits 50a-50n, the components of the data buffers 70a-70n, the components of the RCD circuit 74 and/or the components of the circuit 100 may be in a range of 28 nm to 65 nm. In some embodiments, the fabrication process size may be less than 28 nm. In some embodiments, the fabrication process size may be greater than 65 nm. For example, in a DDR4 implementation, the fabrication process size may be 65 nm. In some embodiments, the components of the memory circuits 50a-50n, the components of the data buffers 70a-70n, the components of the RCD circuit 74 and/or the components of the circuit 100 may be implemented using FinFET technology. For example, FinFET technology may comprise a three-dimensional bar on top of a silicon substrate (e.g., a fin). Implementing FinFET technology instead of planar FET technologies may decrease power consumption, increase switching speed, decrease switching voltage and/or decrease a fabrication size to a range of 10 nm-22 nm. The fabrication process size may be varied according to the design criteria of a particular implementation.

In one example, the clock signal CLK_IN may be transmitted through the coupling interface 104 from a large transmitting inductor to an inductor array of receivers. In another example, the clock signal CLK_IN may be transmitted through the coupling interface 104 inductor-to-inductor, with each inductor having a matching size. The inductor coupling in the RCD 74 (e.g., a DDR4 RCD) and/or in the data buffers 70a-70n may be configured to deliver the data and/or clock through the magnetic inductor coupling. With the inductive coupling from the input receiver and the output transmitter, the data signals and/or clock signal may be delivered simultaneously with minimal delay and/or skew (e.g., without any delay and/or skew). The coupled signals may operate as a short range radio through the air instead of an electrical path. Since no electrical path exists, no delay may be caused by an electrical path.

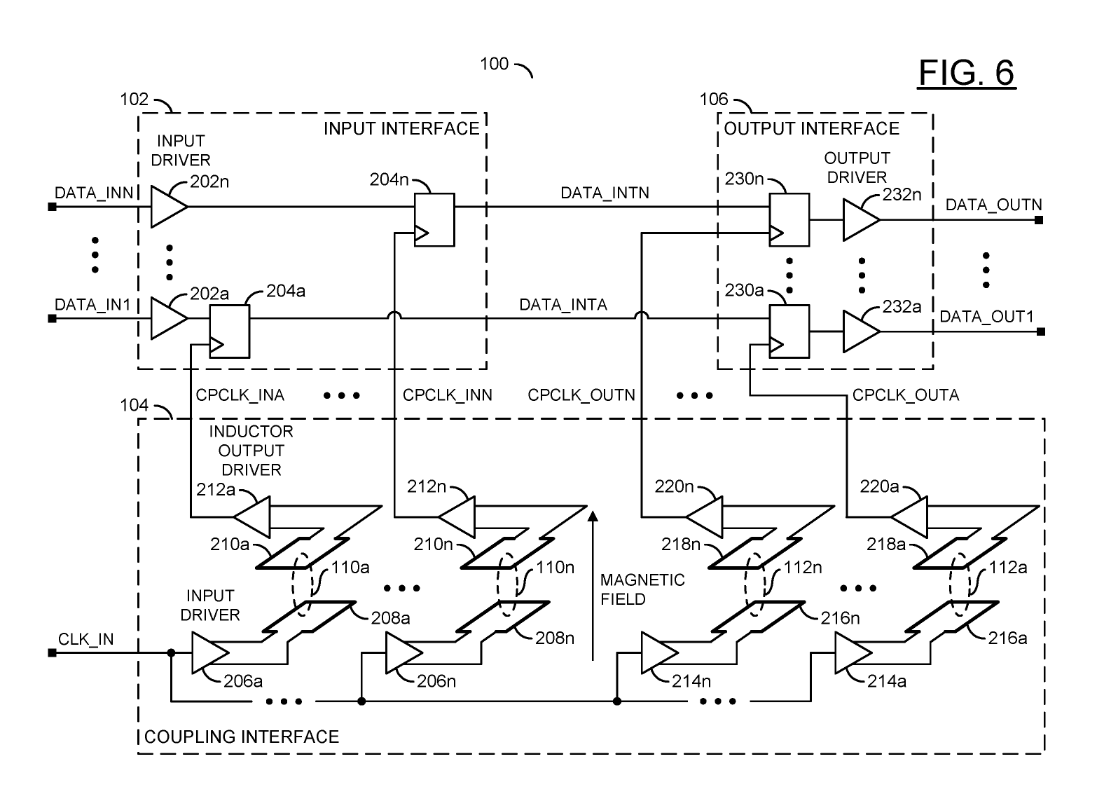

Referring to FIG. 6, a diagram illustrating an example embodiment of the inductive coupling circuit 100 comprising the coupling interface 104 implementing inductor-to-inductor coupling with similar sizes is shown. Components of the input interface 102, the coupling interface 104 and/or the output interface 106 are shown. The circuits 102-106 may comprise other components (not shown). The number and/or types of components implemented in the circuits 102-106 may be varied according to the design criteria of a particular implementation.

The input interface 102 may receive one or more signals (e.g., DATA_IN1-DATA_INN). The signals DATA_IN1-DATA_INN may be data bits of the signal DATA_IN. In one example, the number of bits may be 16 (e.g., DATA_IN1-DATA_IN16). In another example, the number of bits may be 32 (e.g., DATA_IN1-DATAIN32). In yet another example, the number of bits may be 64 (e.g., DATA_IN1-DATA_IN64). The number of bits received and/or transmitted by the input interface 102 may be varied according to the design criteria of a particular implementation.

The signals DATA_IN1-DATA_INN may each be received by an input driver circuit. The interface 102 may comprise blocks (or circuits 202a-202n. The input interface 102 may comprise a plurality of input drivers 202a-202n. The input drivers 202a-202n may receive the signals DATA_IN1-DATA_INN. The number of input drivers 202a-202n implemented may be varied based on the number of data input signals (e.g., DATA_IN1-DATA_INN).

The input interface 102 may comprise a number of blocks (or circuits) 204a-204n. The circuits 204a-204n may implement flip-flop circuits. In one example, the circuits 204a-204n may be D-type flip-flops. Each of the flip-flops 204a-204n may receive a respective one of the signals DATA_IN1-DATA_INN (e.g., at a D input of a D-type flip-flop circuit). For example, the input drivers 202a-202n may each transfer one of the data signals DATA_IN1-DATA_INN to one of the flip-flops 204a-204n. Each of the flip-flops 204a-204n may receive one of the coupled clock signals CPCLK_INA-CPCLK_INN (e.g., at a clock input of the D-type flip-flop).

Each of the flip-flops 204a-204n may present one intermediate signal (e.g., DATA_INTA-DATA_INTN). The intermediate signals DATA_INTA-DATA_INTN may be data bits of the intermediate signal DATA_INT. The number of data bits in the intermediate signal DATA_INT may correspond to the number of data bits in the signal DATA_IN. The signals DATA_INTA-DATA_INTN may be presented by a Q output of the D-type flip-flops 204a-204n.

The input interface 102 may comprise a number of input stages (or input channels). Generally, the input interface 102 comprises at least two input stages. Each input stage of the input interface 102 may comprise one of the input drivers 202a-202n and one of the flip-flops 204a-204n. Each input stage may receive one of the coupled clock signals CPCLK_INA-CPCLK_INN. In one example, one input stage of the input interface 102 may comprise the input driver 202a and the flip-flop 204a and the input stage may receive the data input signal DATA_IN1, the coupled clock signal CPCLK_INA and present the intermediate signal DATA_INTA. In another example, one input stage of the input interface 102 may comprise the input driver 202i and the flip-flop 204i and the input stage may receive the data input signal DATA_INI, the coupled clock signal CPCLK_INI and present the intermediate signal DATA_INTI. The number of data input stages implemented by the input interface 102 may correspond to the number of bits in the input data signal DATA_IN.

The coupling interface 104 may be configured to replace a clock tree used to manage timings for transmitting the data signals. Generally, a clock tree may cause a mismatch between the timings of the transmission of the data bits. For example, in a traditional data path, the flip-flop 204a may not transmit the signal DATA_INTA until the signal CLK_IN is received from the clock tree. Similarly, in a traditional data path, the flip-flop 204n may not transmit the signal DATA_INTN until the signal CLK_IN is received from the clock tree. However, the complexity of the clock tree may introduce a delay. For example, the flip-flop 204a may be farther away from the input for the clock signal CLK_IN than the flip-flop 204n, resulting in the flip-flop 204n receiving the signal CLK_IN before the flip-flop 204a. If the flip-flop 204n receives the signal CLK_IN earlier, the flip-flop 204n may present the signal DATA_INTN before the flip-flop 204a presents the signal DATA_INTA. The mismatch between the transmission of the data bits caused by traditional implementations using a clock tree may result in skew (e.g., the tSkew).

The coupling interface 104 may be configured to prevent a mismatch between the transmission of the data bits. The coupling interface 104 may be located near the input interface 102 and/or the output interface 106. The coupling interface 104 may comprise a number of blocks (or circuits) 206a-206n, a number of blocks (or circuits) 208a-208n, a number of blocks (or circuits) 210a-210n, a number of blocks (or circuits) 212a-212n, a number of blocks (or circuits) 214a-214n, a number of blocks (or circuits) 216a-216n, a number of blocks (or circuits) 218a-218n and/or a number of blocks (or circuits) 220a-220n. The circuits 206a-206n may be input drivers for the input clock signal for the input interface 102. The circuits 208a-208n may be source clock inductors for the input interface 102. The circuits 210a-210n may be receiver clock inductors for the input interface 102. The circuits 212a-212n may be inductor output drivers for the input interface 102. The circuits 214a-214n may be input drivers for the input clock signal for the output interface 106. The circuits 216a-216n may be source clock inductors for the output interface 106. The circuits 218a-218n may be receiver clock inductors for the output interface 106. The circuits 220a-220n may be inductor output drivers for the output interface 106. The adjustment circuit 104 may comprise other components (not shown). The components implemented by the coupling interface 104 may be varied according to the design criteria of a particular implementation.

The input drivers 206a-206n may present the input clock signal CLK_IN to the source clock inductors 208a-208n. The input drivers 214a-214n may present the input clock signal CLK_IN to the source clock inductors 216a-216n. The input drivers 206a-206n and the input drivers 214a-214n may have a similar implementation.

The source clock inductors 208a-208n may each receive the input clock signal CLK_IN. The source clock inductors 208a-208n may generate the inductive couples 110a-110n with a respective one of the receiver clock inductors 210a-210n. By generating the inductive couples 110a-110n, the source clock inductors 208a-208n may present the coupled clock signals CPCLK_INA-CPCLK_INN to the receiver clock inductors 210a-210n based on the signal CLK_IN. For example, a direction of the magnetic field generated by the source clock inductors 208a-208n may be from the source clock inductors 208a-208n to the receiver clock inductors 210a-210n. The source clock inductors 216a-216n may each receive the input clock signal CLK_IN. The source clock inductors 216a-216n may generate the inductive couples 112a-112n with a respective one of the receive clock inductors 218a-218n. By generating the inductive couples 112a-112n, the source clock inductors 216a-216n may present the coupled clock signals CPCLK_OUTA-CPCLK_OUTN to the receiver clock inductors 218a-218n based on the signal CLK_IN. For example, a direction of the magnetic field generated by the source clock inductors 216a-216n may be from the source clock inductors 216a-216n to the receiver clock inductors 218a-218n. The source clock inductors 208a-208n and the source clock inductors 216a-216n may have a similar implementation.

The receiver clock inductors 210a-210n may receive the coupled clock signals CPCLK_INA-CPCLK_INN via the inductive couples 110a-110n. The receiver clock inductors 210a-210n may each present one of the coupled clock signals CPCLK_INA-CPCLK_INN to a respective one of the inductor output drivers 212a-212n. The receiver clock inductors 218a-218n may receive the coupled clock signals CPCLK_OUTA-CPCLK_OUTN via the inductive couples 112a-112n. The receiver clock inductors 218a-218n may each present one of the coupled clock signals CPCLK_OUTA-CPCLK_OUTN to a respective one of the inductor output drivers 220a-220n. The receiver clock inductors 210a-210n and the receiver clock inductors 218a-218n may have a similar implementation.

The inductor output drivers 212a-212n may receive the coupled clock signals CPCLK_INA-CPCLK_INN from the receiver clock inductors 210a-210n. The inductor output drivers 212a-212n may present the coupled clocks signals CPCLK_INA-CPCLK_INN to a respective one of the input stages of the input interface 102 (e.g., one of the flip-flops 204a-204n). The inductor output drivers 220a-220n may receive the coupled clock signals CPCLK_OUTA-CPCLK_OUTN from the receiver clock inductors 218a-218n. The inductor output drivers 220a-220n may present the coupled clocks signals CPCLK_OUTA-CPCLK_OUTN to a respective output stage of the output interface 106. Generally, the inductor output drivers 212a-212n and the inductor output drivers 220a-220n may have a similar implementation.

The coupling interface 104 may comprise an array of source clock inductors (e.g., the inductors 208a-208n and/or the inductors 216a-216n) and an array of receiver clock inductors (e.g., the inductors 210a-210n and/or the inductors 218a-218n). Generally, the number of input drivers 206a-206n, the number of source clock inductors 208a-208n, the number of receiver clock inductors 210a-210n and/or the number of inductor output drivers 212a-212n may be the same as the number of input stages of the input interface 102. Generally, the number of input drivers 214a-214n, the number of source clock inductors 216a-216n, the number of receiver clock inductors 218a-218n and/or the number of inductor output drivers 220a-220n may be the same as the number of output stages of the output interface 106. The number of components implemented by the coupling interface 104 may be varied according to the design criteria of a particular implementation. Generally, the number of input stages of the input interface 102, the number of each type of component of the coupling interface 104 and the number of output stages of the output interface 106 are the same.

The output interface 106 may receive the intermediate signals DATA_INTA-DATA_INTN and/or the coupled clock signals CPCLK_OUTA-CPCLK_OUTN. The output interface 106 may present a number of signals (e.g., DATA_OUT1-DATA_OUTN). The signals DATA_OUT1-DATA_OUTN may be bits of the output signal DATA_OUT. The number of the output signals DATA_OUT1-DATA_OUTN may correspond to the number of the input signals DATA_IN1-DATA_INN and/or the number of the intermediate signals DATA_INTA-DATA_INTN.

The output interface 106 may comprise a number of blocks (or circuits) 230a-230n and/or a number of blocks (or circuits) 232a-232n. The circuits 230a-230n may implement flip-flop circuits. The circuits 232a-232n may implement output drivers. In one example, the circuits 230a-230n may be D-type flip-flops. Each of the flip-flops 230a-230n may receive a respective one of the signals DATA_INTA-DATA_INTN. For example, the input stages of the input interface 102 may each transfer one of the intermediate data signals DATA_INTA-DATA_INTN to one of the flip-flops 230a-230n of the output interface 106.

Each of the flip-flops 230a-230n may receive a respective one of the coupled clock signals CPCLK_OUTA-CPCLK_OUTN. For example, the inductor output drivers 220a-220n of the coupling interface 104 may each transfer one of the coupled output clock signals CPCLK_OUTA-CPCLK_OUTN to one of the flip-flops 230a-230n. The coupled output clock signals CPCLK_OUTA-CPCLK_OUTN may be implemented to ensure a timing match between the data bits transferred from the input interface 102 to the output interface 106. Each of the flip-flops 230a-230n may be configured to present one of the signals DATA_OUT1-DATA_OUTN to the circuits 232a-232n. For example, the flip-flops 230a-230n may each receive one of the intermediate data signals DATA_INTA-DATA_INTN at the D input, one of the coupled output clock signals CPCLK_OUTA-CPCLK_OUTN at the clock input and present one of the signals DATA_OUT1-DATA_OUTN at the Q output.

The output drivers 232a-232n may communicate the signals DATA_OUT1-DATA_OUTN received from the flip-flops 230a-230n as data output. The signals DATA_OUT1-DATA_OUTN may be the output of the output interface 106 and/or the coupling circuit 100. For example, the output interface 106 may implement one of the output drivers 232a-232n for each of the flip-flops 230a-230n.

The output interface 106 may comprise a number of output stages (or output channels). Generally, the output interface 106 comprises at least two output stages. Each output stage of the output interface 106 may comprise one of the flip-flops 230a-230n and one of the output drivers 232a-232n. In one example, one output stage of the output interface 106 may be the flip-flop 230a and the output driver 232a and the output stage may receive the intermediate data input signal DATA_INTA and the coupled clock signal CPCLK_OUTA and present the output data signal DATA_OUT1. In another example, one output stage of the output interface 106 may be the flip-flop 230i and the input driver 232i and the output stage may receive the intermediate data input DATA_INTI and the coupled clock signal CPCLK_OUTI and present the output data signal DATA_OUTI. The number of output stages implemented by the output interface 106 may correspond to the number of bits in the output data signal DATA_OUT.

The input interface 102 may comprise a large group of input stages. The output interface 106 may comprise a large group of output stages. The input stages and/or the output stages may be located at various distances from each other. The differences in the distances from the input stages of the input interface 102 to the various output stages of the output interface 106 may cause a mismatch in the timings of transferring data bits. By coupling the input clock signal CLK_IN to the coupled clock signals CPCLK_INA-CPCLK_INN via the inductive couples 110a-110n and/or the coupled clock signals CPCLK_OUTA-CPCLK_OUTN via the inductive couples 112a-112n, the clock may be received by each component of the data path at the same time. For example, an instantaneous coupling of the signals using inductive coupling may ensure the clock input is received at a common time (e.g., ensuring synchronization of the signals transmitted along the data path).

The coupling interface 104 may be configured to meet a skew specification of the DDR4 (or DDR5) specification. For example, implementing the inductive couples 110a-110n and/or the inductive couples 112a-112n may enable the circuit 100 to balance the clock and data skew while transferring bits at a high data rate. The coupling interface 104 may be implemented to prevent skew from accumulating due to delay variation and/or mismatch between clock and data bits. The coupling interface 104 may be configured to couple the input clock signal CLK_IN (e.g., generate the coupled clock signals CPLK_INA-CPCLK_INN and the coupled clock signals CPCLK_OUTA-CPCLK_OUTN) for each bit transmitted from the input interface 102 to the output interface 106 to reduce and/or eliminate a mismatch between a bit to bit delay by replacing a clock tree for transmitting clock signals with signals that operate as a short range radio through air. For example, the coupling interface 104 may eliminate the clock tree.

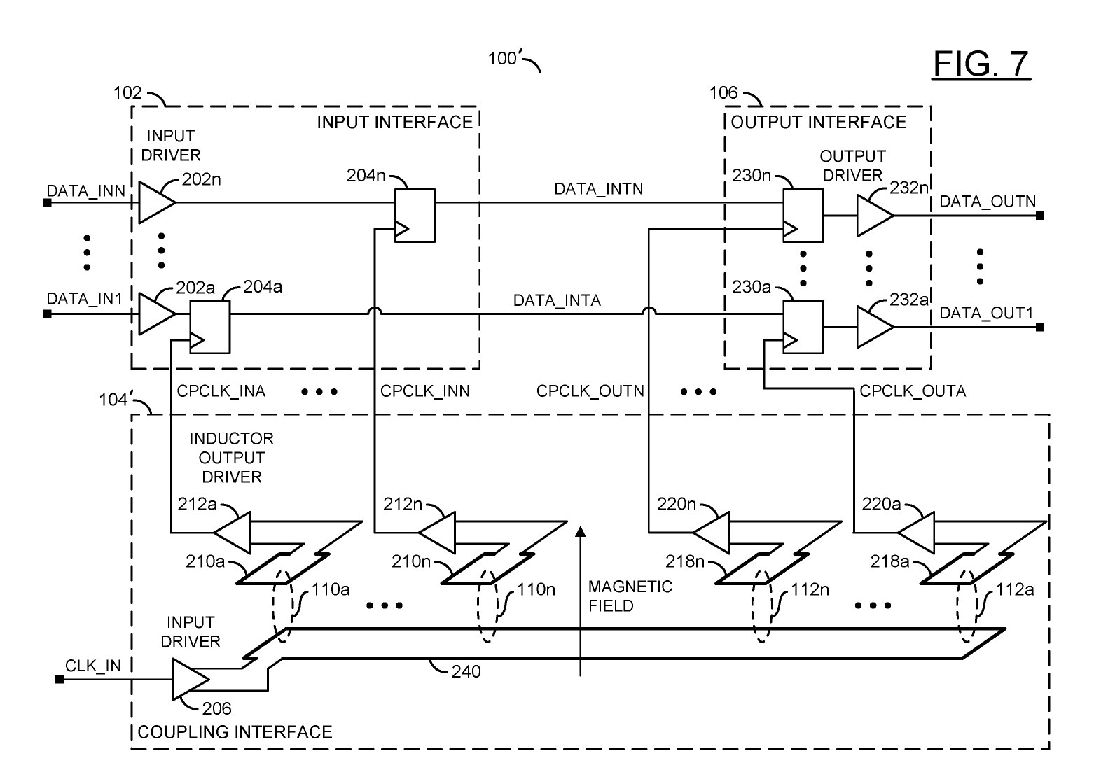

Referring to FIG. 7, a diagram illustrating an example embodiment of the apparatus 100′ comprising the coupling interface 104′ implementing a large transmitter inductor is shown. The coupling circuit 100′ may have a similar implementation as the coupling circuit 100 described in association with FIG. 6. The coupling circuit 100′ may comprise the input interface 102, the output interface 106 and/or the coupling interface 104′.

The coupling interface 104′ may comprise the input driver 206, the receiver clock inductors 210a-210n, the receiver clock inductors 218a-218n, the inductor output drivers 212a-212n, the inductor output drivers 220a-220n and/or a block (or circuit) 240. The circuit 240 may implement a large transmitting inductor. The large transmitting inductor 240 may have a size larger than the receiver clock inductors 210a-210n and/or the receiver clock inductors 218a-218n. The large transmitting inductor 240 may be configured to receive the input clock signal CLK_IN from the input driver 206.

The large transmitting inductor 240 may generate the inductive couples 110a-110n and/or the inductive couples 112a-112n. The large transmitting inductor 240 may be configured to transmit the input clock signal CLK_IN to an array of receivers (e.g., the receiver clock inductors 210a-210n and/or the receiver clock inductors 218a-218n). The input clock signal CLK_IN may be transmitted to each of the receiver clock inductors 210a-210n via the couples 110a-110n. The input clock signal CLK_IN may be transmitted to each of the receiver clock inductors 218a-218n via the couples 112a-112n. The magnetic field generated to induce the couples 110a-110n and/or the couples 112a-112n may be directed from the large transmitting inductor 240 to the array of receivers. The receiver clock inductors 210a-210n may generate the coupled clock signals CPCLK_INA-CPCLK_INN in response to the couples 110a-110n with the large transmitting inductor 240. The receiver clock inductors 218a-218n may generate the coupled clock signals CPCLK_OUTA-CPCLK_OUTN in response to the couples 112a-112n with the large transmitting inductor 240.

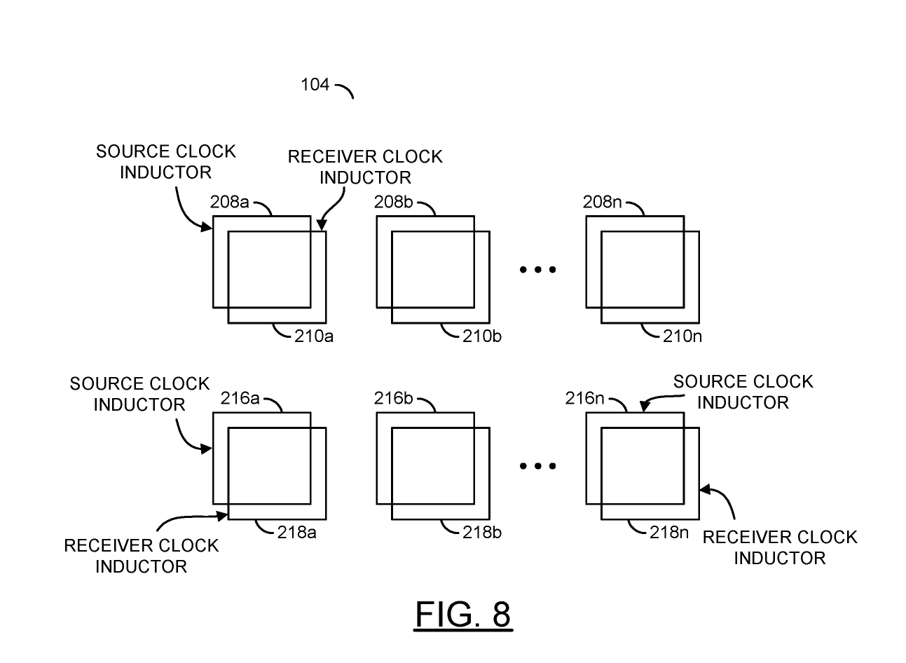

Referring to FIG. 8, a diagram illustrating the coupling interface 104 implementing an array of inductor-to-inductor couples is shown. Each of the source clock inductors 208a-208n may be coupled with one of the receiver clock inductors 210a-210n. Similarly, each of the source clock inductors 216a-216n may be coupled with one of the receiver clock inductors 218a-218n.

The inductor coupling may be implemented to deliver the clock from the source to all the data path flip-flops (e.g., the flip-flops 204a-204n of the input interface 102 and/or the flip-flops 230a-230n of the output interface 106). The coupling interface 104 may implement the inductive coupling using a one-to-one receiver array. For example, each of the source clock inductors 208a may have a corresponding receiver clock inductor 210a-210n. Generally, the size and/or shape of the inductor array implemented by the inductor interface 104 may be approximately the same. For example, the source clock inductors 208a-208n, the receiver clock inductors 210a-210n, the source clock inductors 216a-216n and/or the receiver clock inductors 218a-218n may have a matching size. The size, shape, and/or number of the inductors in the inductor array implemented by the inductor interface 104 may be varied according to the design criteria of a particular implementation. In one example, the source clock inductors 208a-208n may be implemented to be slightly larger than the receiver clock inductors 218a-218n to compensate for slight magnetic energy losses at the edge of the source clock inductors 208a-208n.

Current from the signals CLK_IN passing through the source inductors 208a-208n and/or the source inductors 216a-216n may generate the couples 110a-110n and/or the couples 112a-112n. The couples 110a-110n and/or the couples 112a-112n may induce current through the receiving inductors 210a-210n and/or the receiving inductors 218a-218n. The number of the signals CPCLK_INA-CPCLK_INN may correspond to the number of the flip-flops 204a-204n implemented by the input interface 104. The number of the signals CPCLK_OUTA-CPCLK_OUTN may correspond to the number of the flip-flops 230a-230n implemented by the output interface 106.

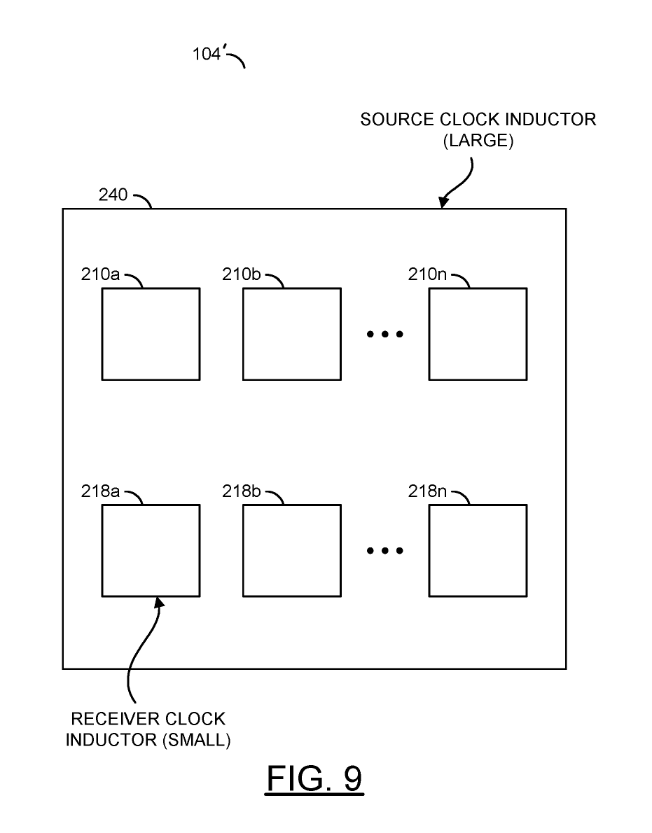

Referring to FIG. 9, a diagram illustrating the coupling interface 104′ implementing the large transmitting inductor 240 and an array of receiving inductors is shown. The inductor 240 may be coupled with each of the receiver clock inductors 210a-210n. Similarly, the inductor 240 may be coupled with each of the receiver clock inductors 218a-218n.

The inductor coupling may be implemented to deliver the clock from the source to all the data path flip-flops (e.g., the flip-flops 204a-204n of the input interface 102 and/or the flip-flops 230a-230n of the output interface 106). The coupling interface 104′ may implement the inductive coupling using a one-to-many receiver array. For example, the inductor 240 may induce a current with each of the inductors 210a-210n and the inductors 218a-218n. Generally, the size and/or shape of the inductors 210a-210n and the inductors 218a-218n may be approximately the same. The size of the inductor 240 may be larger than each of the receiving inductors 210a-210n and/or the receiving inductors 218a-218n. Generally, the size of the large transmitting inductor 240 may correspond to the number of the receiver clock inductors 210a-210n and/or the number of the receiver clock inductors 218a-218n. The size of the large transmitting inductor 240 may be varied according to the design criteria of a particular implementation.

Implementing the source inductor as the large transmitting inductor 240 may enable a more general design for the coupling interface 104″. The large transmitting inductor 240 may allow for changing the number of the receiving inductors 210a-210n and/or 218a-218n without changing the large transmitting inductor 240. For example, more of the receiving inductors 210a-210n and/or 218a-218n may be added and the large transmitting inductor 240 may accommodate the additional inductors.

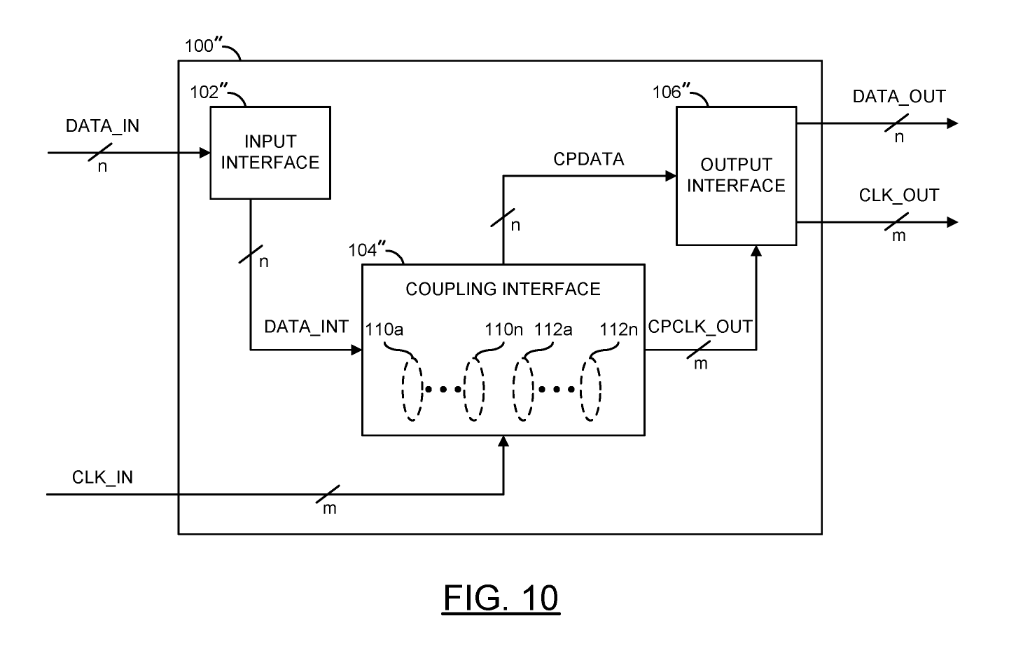

Referring to FIG. 10, a block diagram illustrating an alternate embodiment of the inductive coupling circuit 100″ is shown. The inductive coupling circuit 100″ may be configured to synchronize the clock and/or data signals through the data path. The inductive coupling circuit 100″ may comprise the input interface 102″, the coupling interface 104″ and/or the output interface 106″. Each of the circuits 102″-106″ may comprise one or more blocks (or circuits). The number and/or types of components implemented by the inductive coupling circuit 100″ may be varied according to the design criteria of a particular implementation.

The circuit 100″ may implement a portion of the data path for the circuits 50a-50n. The inductive coupling circuit 100″ may receive the signal DATA_IN. The inductive coupling circuit 100″ may receive the signal CLK_IN. The signal DATA_IN may comprise n bits (e.g., signals DATA_IN1-DATA_INN). The signal CLK_IN may comprise m bits. In one example, the signal CLK_IN may be a 1-bit signal. The inductive coupling circuit 100″ may present the signal DATA_OUT. The signal DATA_OUT may comprise n bits (e.g., signals DATA_OUT1-DATA_OUTN). The inductive coupling circuit 100″ may present a signal (e.g., CLK_OUT). The signal CLK_OUT may be an output clock signal. The signal CLK_OUT may comprise m bits. In one example, the signal CLK_OUT may be a 1-bit signal.

The input interface 102″ may receive the signal DATA_IN. The input interface 102″ may present the signal DATA_INT. The coupling interface 104 may receive the signal CLK_IN and/or the signal DATA_INT. The coupling interface 104″ may present the signal CPCLK_OUT and/or a signal (e.g., CPDATA). The signal CPDATA may be a coupled data signal. The output interface 106″ may receive the signal CPCLK_OUT and/or the signal CPDATA. The output interface 106″ may present the signal DATA_OUT and/or the signal CLK_OUT.

In an example, the data signal DATA_INT may induce the coupled data signal CPDATA in the coupling interface 104″. The signal CPDATA may comprise n bits (e.g., CPDATA1-CPDATAN). The signal CPDATA may be a coupled version of the signal DATA_IN presented to the input interface 102″. Generally, the number of bits of the signal CPDATA may correspond to a number of components of the input interface 102″. The signal CPDATA may be a coupled version of the signal DATA_IN presented to the output interface 106″.

The inductive coupling circuit 100″ may be configured to reduce and/or eliminate mismatch between bit to bit delay and clock tree delay. Synchronizing the clock signal CLK_IN may clean up jitter and/or skew (e.g., adjust tSkew) through the clock line and/or data lines. Synchronizing the data bit signals DATA_IN with the output data signals DATA_OUT may ensure correct timing for the transmission of the data signals. The inductive couples 110a-110n may be configured to synchronize the input signal CLK_IN as the coupled output clock CPCLK_OUT. The inductive couples 112a-112n may be configured to synchronize the input data signals DATA_IN as the coupled data signals CPDATA. The signal CPDATA may be induced in response to the couples 112a-112n. For example, as a result of the inductive couples 112a-112n, the timing of the coupled data signals CPDATA may match the timing of the input data signals DATA_IN.

The inductor coupling signals (e.g., CPCLK_OUT and/or CPDATA) may be delivered globally through the magnetic field in a near field. The magnetic energy of the inductive couples 110a-110n and/or the inductive couples 112a-112n may be received at the same time once the signal CPCLK_OUT and/or the signal CPDATA are transmitted. The inductive couples 110a-110n and/or the inductive couples 112a-112n may enable implementing the data path without a clock tree. Synchronizing the data path signals via the coupled data signals CPDATA may reduce a component count for implementing the circuit 100″. For example, synchronizing the data path signals using the couples 112a-112n may reduce (or eliminate) a number of flip-flops implemented in the input interface 102″ and/or the output interface 106″.

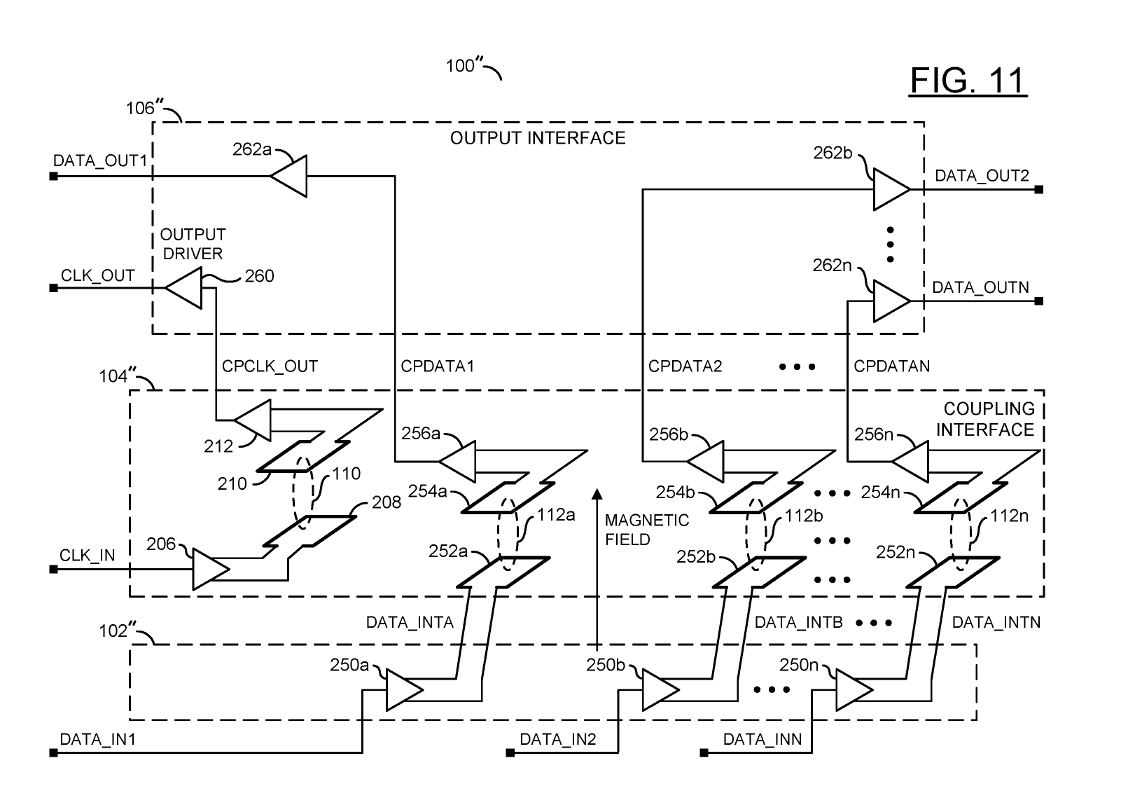

Referring to FIG. 11, a diagram illustrating an example embodiment of the inductor coupling circuit 100″ configured to implement inductor coupling for data and clock signals is shown. The circuit 100″ may comprise the input interface 102″, the coupling interface 104″ and/or the output interface 106″. The circuit 100″ may comprise other components (not shown). The number and/or type of the components of the circuit 100″ may be varied according to the design criteria of a particular implementation.

The inductor coupling circuit 100″ may implement a portion of the data path for the circuits 50a-50n. The coupling circuit 100″ may receive the signals DATA_IN1-DATA_INN, and/or the input clock signal CLK_IN. The coupling circuit 100″ may present the signals DATA_OUT1-DATA_OUTN and/or the signal CLK_OUT. The circuit 100″ may be configured to generate inductive couples to synchronize the input clock signal CLK_IN with the output clock signal CLK_OUT and/or to synchronize the input data signals DATA_IN1-DATA_INN with the output data signals DATA_OUT1-DATA_OUTN.

The input interface 102″ may receive the input data signals DATA_IN1-DATA_INN. The input interface 102″ may present the intermediate data signals DATA_INTA-DATA_INTN. The interface 102″ may comprise blocks (or circuits) 250a-250n. The circuits 250a-250n may implement input drivers. The input drivers 250a-250n may each receive one of the input data signals DATA_IN1-DATA_INN and generate a corresponding one of the intermediate data signals DATA_INTA-DATA_INTN. The drivers 250a-250n may have a similar implementation as the input clock driver 206. Synchronizing the data signals DATA_IN1-DATA_INN using the couples 112a-112n may eliminate a need for flip-flop circuits in the input interface 102″. Eliminating flip-flop circuits may reduce a cost of the apparatus 100 while maintaining an integrity of the timing of the signals DATA_IN1-DATA_INN throughout the data path.

The coupling interface 104″ may receive the signals DATA_INTA-DATA_INTN and/or the input clock signal CLK_IN. The coupling interface 104″ may generate the signal CPCLK_OUT and/or signals (e.g., CPDATA1-CDATAN). The signals CPDATA1-CPDATAN may comprise coupled data signals. In an example, the data signal DATA_INTA may induce the coupled data signal CPDATA1 in the coupling interface 104″. Inducing the signal CPCLK_OUT and/or the signals CPDATA1-CPDATAN may synchronize the timing of the input signals of the data path with the output signals of the data path.

The coupling interface 104″ may comprise the driver 206, the source inductor 206, the receiver inductor 210 and/or the driver 212. The inductive couple 110 may be generated between the source inductor 206 and the receiver inductor 210. The inductive couple 110 may synchronize the input clock signal CLK_IN with the coupled clock signal CPCLK_OUT.

The coupling interface 104″ may further comprise blocks (or circuits) 252a-252n, blocks (or circuits) 254a-254n and/or blocks (or circuits) 256a-256n. The circuits 252a-252n may implement data input inductors. The circuits 254a-254b may implement data output inductors. The circuits 256a-256n may implement drivers. In an example, the drivers 256a-256n may comprise inductor data output drivers. The number of the circuits 252a-252n, the circuits 254a-254n and/or the circuits 256a-256n may correspond to the number of data input signals DATA_IN1-DATA_INN. The number of components of the coupling interface 104″ may be varied according to the design criteria of a particular implementation.

The inductive couples 112a-112n may be generated between the data input inductors 252a-252n and the data output inductors 254a-254n. The inductive couples 112a-112n may synchronize the input data signals DATA_IN1-DATA_INN with the coupled data signals CPDATA1-CPDATAN. The coupling interface 104″ may implement the couple 110 and/or the couples 112a-112n to individually couple the clock and data signals. In the example shown, one clock signal may be coupled. In some embodiments, many clock signals may be coupled. The coupling interface 104″ may transmit the input signals (e.g., the input clock signal CLK_IN and/or the data signals DATA_IN1-DATA_INN) from the inductor array for transmitting (e.g., the inductor 208 and/or the inductors 252a-252n) to a matching inductor array for the receiver (e.g., the inductor 210 and/or the inductors 254a-254n). For example, the magnetic field generated by the coupling interface 104″ may be in a direction from the source inductor 208 and/or the source inductors 252a-252n to the receiver inductor 210 and/or the receiver inductors 254a-254n. In one example, the source clock inductors 208a-208n may be implemented to be slightly larger than the inductors 254a-254n to compensate for slight magnetic energy losses at the edge of the source clock inductors 208a-208n.

The output interface 106″ may receive the coupled clock signal CPCLK_OUT and/or the coupled data signals CPDATA1-CPDATAN. The output interface 106″ may present the output clock signal CLK_OUT and/or the output data signals DATA_OUT1-DATA_OUTN. The interface 106″ may comprise a block (or circuit) 260 and/or blocks (or circuits) 262a-262n. The circuit 260 and/or the circuits 262a-262n may implement output drivers. In one example, the output driver 260 may implement an output clock driver. In an example, the drivers 262a-262n may implement output data drivers. The output driver may receive the coupled clock signal CPCLK_OUT and generate the output clock signal CLK_OUT. The output drivers 262a-262n may each receive one of the coupled data signals CPDATA1-CPDATAN and generate a corresponding one of the output data signals DATA_OUT1-DATA_OUTN. The driver 260 and/or the drivers 262a-262n may have a similar implementation as the output drivers 232a-232n (described in association with FIG. 6). Synchronizing the data signals DATA_OUT1-DATA_OUTN using the couples 112a-112n may eliminate a need for flip-flop circuits in the output interface 106″. Eliminating flip-flop circuits may reduce a cost of the apparatus 100 while maintaining an integrity of the timing of the signals DATA_OUT1-DATA_OUTN throughout the data path.

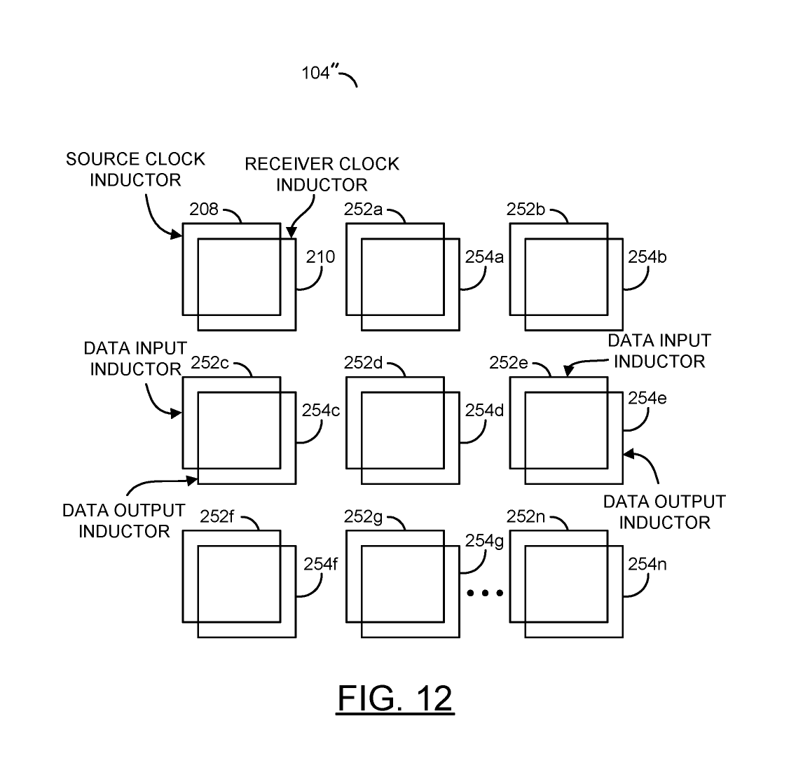

Referring to FIG. 12, a diagram illustrating the coupling interface 104″ implementing a clock inductor couple and an array of data inductor couples is shown. The source clock inductor 208 may be coupled with the receiver clock inductors 210. Each of the data input inductors 252a-252n may be coupled with one of the data output inductors 254a-254n.

The inductor coupling may be implemented to deliver the clock and/or data signals through the data path at the same time. The coupling interface 104″ may implement the inductive coupling of the clock and/or data signals using a one-to-one receiver array. For example, the source clock inductors 208 may have a corresponding receiver clock inductor 210. In an example, each of the data input inductors 252a-252n may have a corresponding one of the data output inductor 254a-254n. Generally, the size and/or shape of the inductor array implemented by the inductor interface 104″ may be approximately the same. For example, the source clock inductor 208, the receiver clock inductor 210, the data input inductors 252a-252n and/or the data output inductors 254a-254n may have a matching size. The size, shape, and/or number of the inductors in the inductor array implemented by the inductor interface 104″ may be varied according to the design criteria of a particular implementation. In one example, the data input inductors 252a-252n may be implemented to be slightly larger than the data output inductors 254a-254n to compensate for slight magnetic energy losses at the edge of the source clock inductors 208a-208n.

Although embodiments of the invention have been described in the context of a DDR4 application, the present invention is not limited to DDR4 applications, but may also be applied in other high data rate digital communication applications where different transmission line effects, cross-coupling effects, traveling wave distortions, phase changes, impedance mismatches and/or line imbalances may exist. The present invention addresses concerns related to high speed communications, flexible clocking structures, specified command sets and lossy transmission lines. Future generations of DDR can be expected to provide increasing speed, more flexibility, additional commands and different propagation characteristics. The present invention may also be applicable to memory systems implemented in compliance with either existing (legacy) memory specifications or future (e.g., DDR5) memory specifications.

The terms “may” and “generally” when used herein in conjunction with “is(are)” and verbs are meant to communicate the intention that the description is exemplary and believed to be broad enough to encompass both the specific examples presented in the disclosure as well as alternative examples that could be derived based on the disclosure. The terms “may” and “generally” as used herein should not be construed to necessarily imply the desirability or possibility of omitting a corresponding element.

While the invention has been particularly shown and described with reference to embodiments thereof, it will be understood by those skilled in the art that various changes in form and details may be made without departing from the scope of the invention.

1. An apparatus comprising:
an input interface comprising a plurality of input stages each configured to (i) receive a data signal and a coupled clock signal and (ii) present an intermediate signal;
an output interface comprising a plurality of output stages each configured to (i) receive said intermediate signal from one of said input stages, (ii) receive said coupled clock signal and (iii) present an output signal; and
a coupling interface configured to (i) receive said clock signal and (ii) present said coupled clock signal to each of (a) said input stages and (b) said output stages, wherein (a) said coupling interface generates a plurality of inductive couples and (b) said inductive couples enable a synchronization of said coupled clock signal with said clock signal for each of said input stages and said output stages.

2. The apparatus according to claim 1, wherein said coupling interface is configured to synchronize said coupled clock signal for each bit transmitted from said input interface to said output interface to reduce a mismatch between a bit to bit delay and a delay transmitting said clock signal.

3. The apparatus according to claim 1, wherein said coupling interface is implemented to eliminate a clock tree.

4. The apparatus according to claim 1, wherein (i) said input stages and said output stages each comprise a flip-flop and (ii) said coupling interface is configured to deliver said coupled clock signal to all data path flip-flops.

5. The apparatus according to claim 1, wherein said coupling interface is configured to deliver said coupled clock signal globally through a magnetic field in a near field.

6. The apparatus according to claim 1, wherein said inductive couples enable magnetic energy to be received at the same time once said clock signal is transmitted.

7. The apparatus according to claim 1, wherein said coupling interface comprises an array of transmitting inductors and an array of receiving inductors.

8. The apparatus according to claim 7, wherein (i) said inductive couples are formed inductor-to-inductor and (ii) each of said transmitting inductors and said receiving inductors have a matching size.

9. The apparatus according to claim 1, wherein said coupling interface comprises one transmitting inductor coupled to an array of receiving inductors.

10. The apparatus according to claim 9, wherein said transmitting inductor is larger than each of said receiving inductors.

11. The apparatus according to claim 1, wherein said inductive couples are configured to deliver said clock signal to each component of a data path (a) simultaneously and (b) with minimal delay and skew.

12. The apparatus according to claim 1, wherein said coupled clock signal operates as a short range radio through air instead of an electrical path.

13. The apparatus according to claim 1, wherein said coupling interface comprises (a) a first driver configured to receive said clock signal, (b) a first inductor, (c) a second inductor and (d) a second driver configured to present said coupled clock signal.

14. The apparatus according to claim 13, wherein said first inductor and said second inductor are configured to induce one of said inductive couples to enable said synchronization.

15. The apparatus according to claim 1, wherein said apparatus implements inductive coupling for data communication in a double data rate memory system.

16. An apparatus comprising:
an input interface comprising a plurality of input stages each configured to (a) receive an input signal and (b) present an intermediate signal;
an output interface comprising a plurality of output stages each configured to (a) receive coupled intermediate signals and (b) present an output signal; and
a coupling interface configured to (a) receive a clock signal, (b) receive each of said intermediate signals and (c) present said coupled intermediate signals to a corresponding one of said output stages, wherein (i) said coupling interface generates a plurality of inductive couples and (b) said inductive couples enable a synchronization of said coupled intermediate signals with at least one of said input signals and said clock signal for each of said output stages.

17. The apparatus according to claim 16, wherein one of said coupled intermediate signals is based on said clock signal.

18. The apparatus according to claim 16, wherein said coupled intermediate signals comprise data signals.

19. The apparatus according to claim 16, wherein (i) said coupling interface comprises a transmitting inductor array and a receiving inductor array and (ii) each of said inductive couples is between one inductor of said transmitting inductor array and a corresponding inductor of said receiving inductor array.

20. The apparatus according to claim 19, wherein said clock signal and data signals are individually coupled by said inductive couples and transmitted from said transmitting inductor array to said receiving inductor array.
